(19) United States
(12) Patent Application Publication
(10) Pub. No.: US 2004/0088314 A1
(43) Pub. Date: May 6, 2004

(54) Method and system for reporting performance data for a network

(76) Inventor: Scott T. Simes, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/284,347

(22) Filed: Oct. 31, 2002

(51) Int. Cl. G06F 7/00; G06F 17/00

(52) U.S. Cl. 707/102

(57) ABSTRACT

A method and system are used for reporting performance data for a network. The method includes the step of receiving a request for performance data for one or more devices in the network. The requested performance data for the devices is retrieved and then summarized into individual summaries. Values are then assigned to each individual summary. Each assigned value represents the retrieved performance data summarized over a user-specified period. The individual summaries are sorted based on their assigned values, whereby a list of sorted summaries is created. The list of sorted summaries is then reported to a user.

### TECHNICAL FIELD

The technical field is reporting of performance data retrieved from a network, specifically methods and systems for reporting performance data for a network.

### BACKGROUND

Performance data in a storage area network (SAN) may be retrieved in order to monitor the performance of devices in the SAN and to provide information required to analyze storage performance. Data may be collected at a central location and used to optimize storage capacity, manage unpredictability in storage performance and prepare for upgrade changes to the SAN.

Current methods typically involve obtaining the desired performance data for each device in the SAN on a piece-meal basis. Therefore, viewing collected performance data across multiple devices in the SAN at one time using these methods is difficult and time consuming. Since performance data must be obtained separately for each device, current methods do not facilitate analysis of SAN performance, which often require comparison of performance data collected for disparate devices in the SAN. The difficulty and inefficiency of current methods is compounded for SANs having many devices, often of differing types.

### SUMMARY

Disclosed is a method and system for reporting performance data for a network that overcomes the disadvantages of the prior art. The method includes the step of receiving a request for performance data for one or more devices in the network. The requested performance data for the devices is retrieved and then summarized into individual summaries. Values are then assigned to each individual summary. Each assigned value represents the retrieved performance data summarized over a user-specified period. The individual summaries are sorted based on their assigned values, whereby a list of sorted summaries is created. The list of sorted summaries is then reported to a user.

The system includes one or more devices in the network and processing means operably coupled to the devices. The processing means includes receiving means for receiving a request for performance data for the devices, where the request comprises one or more input parameters. The processing means also includes retrieving means for retrieving the requested performance data for the devices based on the input parameters and summarizing means for summarizing the retrieved performance data for each device. Individual summaries are created and a value is assigned to each individual summary. Each assigned value represents the retrieved performance data summarized over a user-specified period. The processing means also includes sorting means for sorting the individual summaries by the assigned values based on the input parameters, whereby a list of sorted summaries is created. Reporting means for reporting the list of sorted summaries based on the input parameters is also included in the processing means.

Also disclosed is a computer readable medium including instructions for reporting performance data for a network. The instructions include receiving a request for performance data for one or more devices in the network. The requested performance data for the devices is retrieved and then summarized into individual summaries. Values are then assigned to each individual summary. Each assigned value represents the retrieved performance data summarized over a user-specified period. The individual summaries are sorted based on their assigned values, whereby a list of sorted summaries is created. The list of sorted summaries is then reported to a user.

Other aspects and advantages are apparent from the following detailed description, in conjunction with the accompanying figures.

### DESCRIPTION OF THE DRAWINGS

The detailed description will refer to the following drawings, wherein like numerals refer to like elements, and wherein:

FIG. 1 is a schematic diagram of a system for reporting performance data for a storage area network;

FIG. 2 is a flow diagram of one embodiment of a method for reporting performance data across one or more devices in the storage area network;

FIG. 3 is a flow diagram of one embodiment of a method for reporting a single performance metric across multiple devices of similar type in the storage area network;

FIG. 4 is a flow diagram of one embodiment of a method for reporting a single performance metric across multiple sub-units of multiple devices of similar type in the storage area network; and

FIG. 5 illustrates exemplary hardware components of a computer that may be used in connection with the method for reporting performance data for the storage area network.

### DETAILED DESCRIPTION

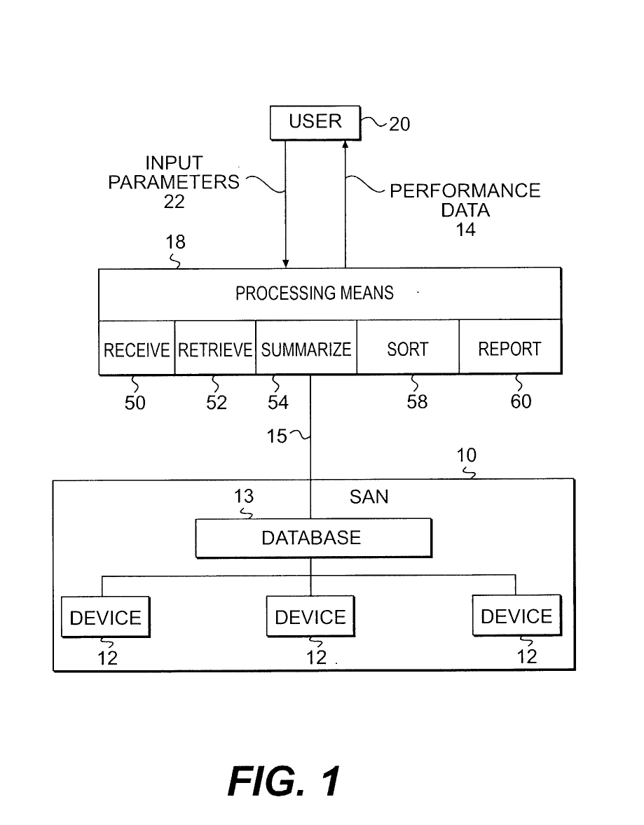

FIG. 1 is a schematic diagram of a system for reporting performance data, or performance metrics, for a storage area network (SAN) 10. The SAN 10 may be a network of various linked devices 12 including, for example, workstations, servers, disk arrays, tape-backup systems and other related devices. The devices 12 may be of various device types including, for example, host devices, storage devices, interconnect devices, host bus adapter devices and network attached storage devices. The SAN 10 may be connected, for example, by using optical fiber channels, conventional copper land lines or wireless communication links. Performance data 14 for the devices 12 may be stored in a database 13. The user 20 may access the database 13 and retrieve performance data 14 using, for example, query language, such as structured query language (SQL), using a coupling 15. The coupling 15 may comprise, for example, optical fiber channels, conventional copper land lines or wireless communication links.

Performance data 14 may include, for example, Device Total Operations over time, which is a measure of the total number of reads and writes performed by a particular device in the SAN 10. Performance data 14 also may include Port Total Received Bytes over time, which is a measure of the number of bytes transmitted through a port on a switch or interconnect device.

Performance data 14 may be retrieved by processing means 18 in order to monitor, manage and optimize storage performance of the SAN 10. The processing means 18 may comprise one or more suitably programmed general purpose processors, specially programmed processors, or ASICS, for example. The processing means 18 is operably coupled to the devices 12.

The processing means 18 may also include various components to process performance data and to communicate with the user 20. For example, the processing means 18 may include receiving means 50 for receiving a request for performance data from the user 20. The receiving means 50 may comprise an interface (not shown) to a computer keyboard and/or a computer mouse. The user 20 may interface the processing means 18 using an interface such as a graphical user interface (GUI) or a command line user interface (CLUI). The request may include one or more input parameters 22 specified by the user 20. Examples of input parameters may include desired performance metrics, specific devices, device types, time periods, sorting arrangements and truncation limits.

The processing means 18 may also include retrieving means 52 for retrieving the performance data 14 for the devices 12 based on the input parameters 22. The retrieving means 52 may generate queries based on requests received from the user 20. Performance data 14 may be retrieved from each device 12 on an individual basis using the queries.

The retrieving means 52 may comprise algorithms that process the request and translate the request into a query format that is compatible with the database 13 containing the performance data 14. The queries are capable of retrieving the requested performance data 14 from the database 13.

The input parameters 22 may be incorporated into the generated queries that are used to retrieve the requested performance data 14 from the database 13. The input parameters 22 determine the scope of the query. The scope of the query defines the kinds of performance data 14 to be retrieved from the database 13. For example, the input parameters 22 may define the scope of the query to retrieve performance data 14 for a specific device type in the SAN 10, such as interconnect devices, over a specific period. Additionally, the input parameters 22 may be used to control how retrieved data is sorted and processed by the processing means 18. For example, the input parameters 22 may direct the processing means 18 to sort the retrieved data in an ascending or a descending order. Further, the input parameters 22 may be used to manage how retrieved data is reported to the user 20. For example, the user 20 may submit a truncation parameter to restrict the amount of data to be reported. The truncation parameter may be a numerical value indicating a number of data fields to be reported. The input parameters 22 may be specified by the user 20 each time a request is transmitted to the processing means 18. Alternatively, the input parameters 22 may be stored as a default in the processing means 18 to be automatically incorporated with the query.

The processing means 18 may also include summarizing means 54 for summarizing individual performance data 14 retrieved for each individual device 12 into an individual performance data summary. The summarizing means 54 may include one or more algorithms for implementing a summarization process. The summarization process is accomplished through data manipulation for defined performance data types. For example, the summarization process may convert raw performance data values retrieved from the database 13 by the retrieving means 52 into a time-ordered, non-overlapping list of data to be processed. The raw performance data values may be represented by data points, where each data point may represent a discrete period of time. Each data point has an associated expected time interval and an actual time interval. The summarization process may order the raw performance data values based on the actual time interval for each data point divided by the expected time interval that the data point should represent. Once the ordering process has been accomplished, the collection of raw performance data values may be converted, using performance data type specific operations, into a single summarized performance data value that is representative of the entire time interval. The summarization process may vary for different types of performance data 14 retrieved from the database 13.

The summarizing means 54 is capable of assigning a single summarized performance data value to each individual summary and maintaining the identity of each individual summary. As discussed above, the value assigned to each individual summary may represent the retrieved performance data 14 for the respective device 12 summarized over a user-specified period. For example, if the user 20 requests performance data for a device over a twenty-four hour period, where the performance data of the device is measured once an hour, the value assigned to the individual summary for the device may represent an average value of the performance data measurements taken over the twenty-four hour period. Alternatively, the value assigned to an individual summary may be the sum of performance data measurements taken over the user-specified period. The summarizing means 54 may comprise an algorithm stored in the processing means 18 that is capable of performing the summarizing of the performance data 14 and assigning a value to the individual summaries.

The processing means 18 also includes sorting means 58 for sorting the individual summaries by their assigned values based on the input parameters 22 provided by the user 20. The sorting means 58 may comprise one or more algorithms that are capable of sorting the individual summaries in ascending or descending order. The sorting means 58 produces a list of sorted summaries. The list of sorted summaries is reported to the user 20 based on the input parameters 22 by reporting means 60. The reporting means 60 may comprise an interface (not shown) to a computer monitor or display. The list of sorted summaries may be reported to the user 20 on the computer monitor or display. Additionally, the reporting means 60 may comprise one or more algorithms for truncating the list of sorted summaries. The algorithms may use a truncation limit specified by the user 20 in the request to truncate the list of sorted summaries.

The processing means 18 may be implemented in software, such as software modules, for execution by computers or other machines. The processing means 18 may be a module or component of software (not shown). The receiving 50, retrieving 52, summarizing 54, sorting 58 and reporting 60 means may also be implemented as software modules, for example, as sub-modules of the processing means 18 or as individual software modules (not shown).

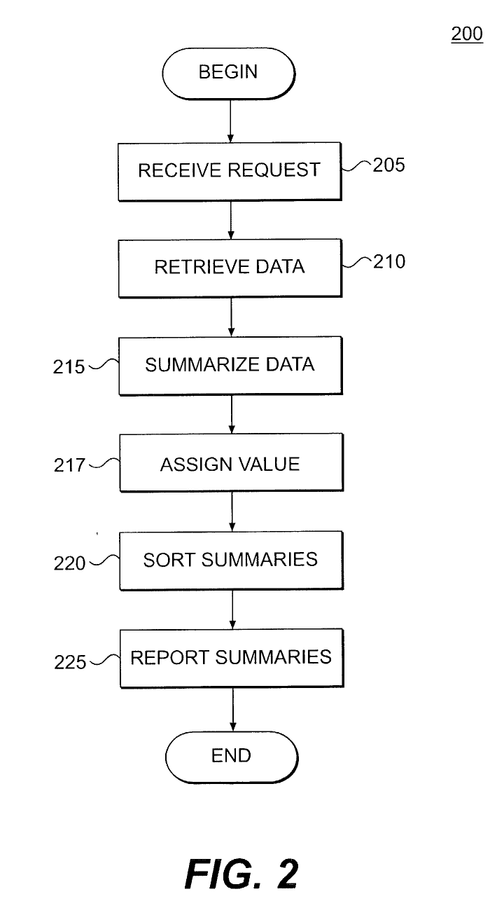

FIG. 2 is a flow diagram 200 of an embodiment of a method for reporting performance data across one or more devices 12 in the SAN 10. In step 205, a request for performance data retrieval is received by the processing means 18 from the user 20. The user 20 submits the input parameters 22 in the request. As discussed above, the input parameters 22 determine the scope of the performance data 14 to be retrieved from the database 13. In step 210, the performance data 14 requested by the user 20 is retrieved.

In step 215, individual performance data retrieved for each device 12 is summarized by the processing means 18 into individual summaries. In step 217, the individual summaries are assigned a summarized performance data value. As discussed above, the summarized performance data value assigned to each individual summary represents the retrieved performance data 14 for the respective device 12 summarized over a user-specified period. In step 220, the individual summaries are sorted based on their respective assigned values in an arrangement determined by the input parameters 22. For example, the input parameters 22 may indicate that the individual summaries be sorted according to an ascending or descending order. The sorting step 220 creates a list of sorted summaries. In step 225, the list of sorted summaries is reported to the user 20 in a format determined by the input parameters 22 submitted by the user 20. For example, the user 20 may specify that the list of sorted summaries be truncated before being reported.

The user 20 is able to view and compare the desired performance metric of the devices 12 in the SAN 10 for the user-specified period. By sorting the list of summaries in an ascending or descending order, the user 20 may quickly identify devices in the SAN 10 that are performing most effectively and least effectively for a specific performance metric. The quantity of reported data may also be restricted for ease of viewing and the order in which data is reported may be altered for convenience. Therefore, the user 20 is provided with the capability to quickly view the operation of the SAN 10 and to identify problem areas, such as, for example, potential or actual bottlenecks in storage capacity in the SAN 10.

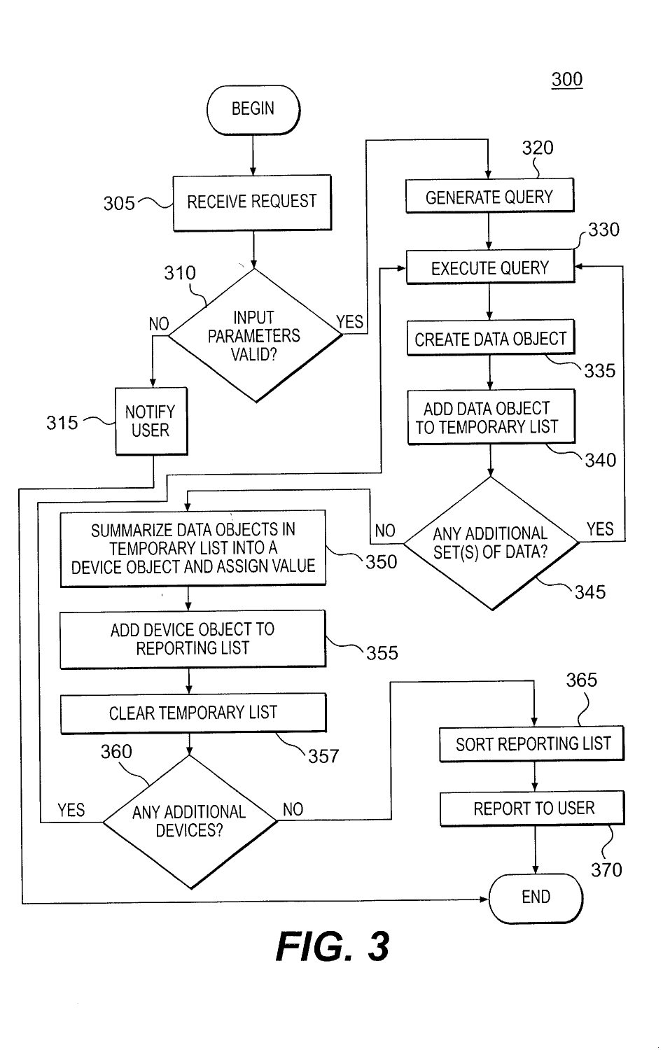

FIG. 3 is a flow diagram 300 of an embodiment of a method for reporting a single performance metric across multiple devices 12 of similar type in the SAN 10. In this embodiment, the user 20 may be, for example, seeking a specific performance metric, such as Device Total Operations over a specific period, for all storage devices in the SAN 10.

In step 305, a request for performance data retrieval is received from the user 20 by the processing means 18. The user 20 specifies input parameters 22 in the request, including desired performance metric and period. In step 310, the processing means 18 determines whether the input parameters 22 are valid. For example, the processing means 18 compares the input parameters 22 with a list of acceptable parameters for the SAN 10. The list of acceptable parameters may be stored in the processing means 18. The input parameters 22 are determined to be valid if the input parameters 22 match one or more of the acceptable parameters. If the input parameters 22 are invalid, the user 20 is notified in step 315. The user 20 may be notified, for example, by transmitting a prompt from the processing means 18 to a computer monitor or display at the user's location.

If the input parameters 22 are valid, the processing means 18 generates a query in step 320 using the information contained in the request submitted by the user 20. As discussed above, the input parameters 22 determine the scope of the performance data 14 to be retrieved by the query, which retrieves requested performance data 14 from the database 13.

In step 330, the query is executed with respect to a first set of performance data 14 of a first device 12. The first set of performance data 14 may, for example, represent the requested performance metric over a first period. In step 335, a first data object is created containing the retrieved first set of performance data 14 for the first device 12. A data object may comprise one or more data structures that contain performance data 14. In step 340, the first data object is added to a temporary list corresponding to the first device 12.

In step 345, the processing means 18 determines whether there are any additional set(s) of requested performance data 14 for the first device 12. If so, the method returns to step 330 and the query is executed with respect to the next set of requested performance data 14 for the first device 12. The additional sets of requested performance data 14 may, for example, represent the requested performance metric over additional periods. An iteration of steps 330 to 345 may be performed for each additional set of requested performance data 14, where an additional data object is created for each additional set of requested performance data 14 and additional data objects are added to the temporary list corresponding to the first device 12.

Once the processing means 18 determines there are no additional sets of requested performance data 14, step 350 is performed. In step 350, the data objects accumulated in the temporary list corresponding to the first device 12 are summarized into a first device object corresponding to the first device 12 and assigned a summarized performance data value. A device object may comprise one or more data structures that contain summarized performance data 14. The first device object is added to a reporting list in step 355. The temporary list is then cleared in step 357.

In step 360, the processing means 18 determines whether there are any additional devices 12 from which performance data 14 is to be retrieved. If so, the method returns to step 330 and the query is executed with respect to one or more sets of performance data 14 of the additional devices 12. Steps 330 to 357 then may be repeated for each additional device 12.

In step 365, the device objects accumulated in the reporting list are sorted based on their assigned values in a manner determined by the input parameters 22. For example, the input parameters 22 may indicate that the device objects be sorted according to an ascending order. In step 370, the reporting list is provided to the user 20 in a format based on the input parameters 22. For example, the user 20 may specify truncation restrictions for the reporting list.

An example of an application of the method illustrated in FIG. 3 is a request for the performance metric Device Total Operations (described above) over the last twenty-four hours for all storage arrays in the SAN 10. The user 20 would specify the performance metric to be retrieved and the period as part of the input parameters 22. Device Total Operations data would then be retrieved for the storage arrays. If there were fifteen storage arrays in the SAN 10, a list of fifteen summarized values would be generated and reported to the user 20. Each value would represent the Device Total Operations performance metric of each storage array, where the Device Total Operations performance metric is summarized into a single value representing the last twenty-four hours. The list of values would be sorted and reported back to the user 20 according to a user-specified manner.

The method illustrated in FIG. 3 may also be applied to report a single performance metric across multiple sub-units of a single device in the SAN 10. For example, the user 20 may desire to view the performance metric Port Total Received Bytes (described above) for every port on a single interconnect device. The user 20 would specify the desired performance metric, a period and an individual device 12 in the SAN 10 in the input parameters 22. A list of summarized data values for Port Total Received Bytes for the ports of the interconnect device would be generated and reported to the user 20.

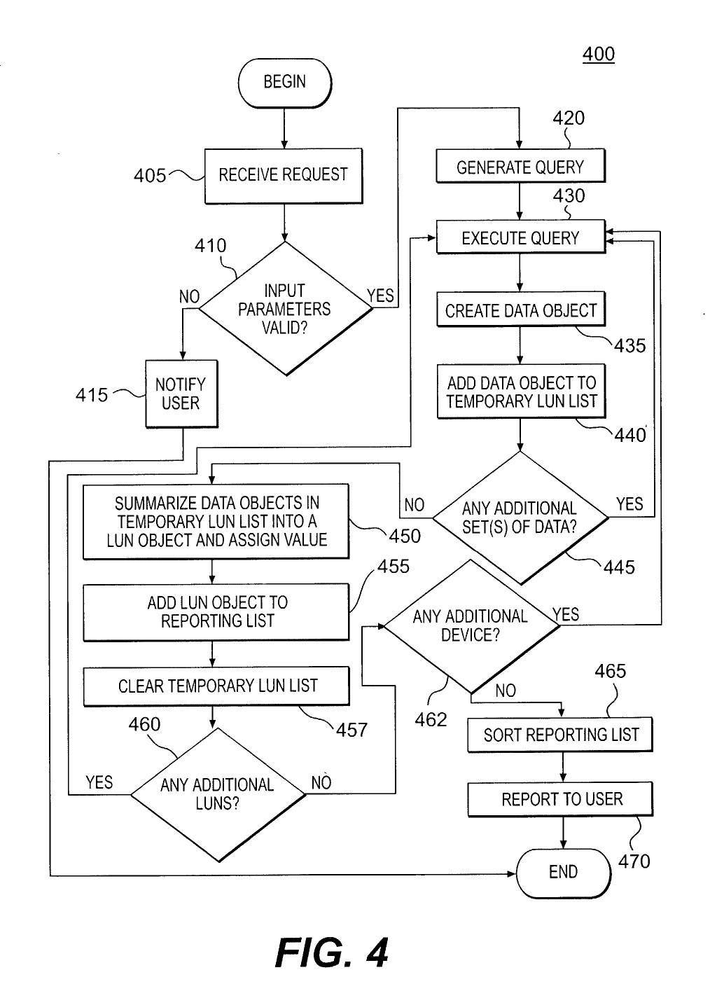

FIG. 4 is a flow diagram 400 of an embodiment of a method for reporting a single performance metric across multiple sub-units of multiple devices 12 of similar type in the SAN 10. In this embodiment, the user 20 may be, for example, seeking a specific performance metric, such as Lun (logical unit) Total Operations over a specific period of time, for all storage arrays in the SAN 10. A lun may be a sub-unit of a device 12 in the SAN 10. Lun Total Operations is a measure of the total number of reads and writes performed by a particular lun of a device 12 in the SAN 10. The performance data 14 retrieved enables the user 20 to view data across sub-units, regardless of the device 12 to which each sub-unit corresponded.

In step 405, a request for performance data retrieval is received from the user 20 by the processing means 18. The user 20 specifies input parameters 22 in the request, including desired performance metric and period. In step 410, the processing means 18 determines whether the input parameters 22 are valid. If the input parameters 22 are invalid, the user 20 is notified in step 415. If the input parameters 22 are valid, the processing means 18 generates a query in step 420 using the information contained in the request submitted by the user 20. As discussed above, the input parameters 22 determine the scope of the performance data 14 to be retrieved by the query, which retrieves requested performance data 14 from the database 13.

In step 430, the query is executed with respect to a first set of performance data 14 of a first lun of a first device 12. The first set of performance data 14 may, for example, represent the requested performance metric over a first period. In step 435, a first data object is created containing the retrieved first set of performance data 14 for the first lun of the first device 12. In step 440, the first data object is added to a temporary lun list corresponding to the first device 12.

In step 445, the processing means 18 determines whether there are any additional set(s) of requested performance data 14 for the first lun of the first device 12. If so, the method returns to step 430 and the query is executed with respect to the additional sets of requested performance data 14 for the first lun for the first device 12. The additional sets of requested performance data 14 may, for example, represent the requested performance metric over additional periods. An iteration may be performed for each additional set of requested performance data 14 for the first lun, where an additional data object is created for each additional set of requested performance data 14 and additional data objects are added to the temporary lun list corresponding to the first device 12.

Once the processing means 18 determines there are no additional sets of requested performance data 14, step 450 is performed. In step 450, the data objects accumulated in the temporary lun list corresponding to the first device 12 are summarized into a first lun object corresponding to the first device 12 and assigned a value. The first lun object is added to a reporting list in step 455. The temporary lun list is then cleared in step 457.

In step 460, the processing means 18 determines whether there are any additional luns of the first device 12 from which performance data 14 is to be retrieved. If so, the method returns to step 430 and the query is executed with respect to one or more sets of performance data 14 of the additional luns of the first device 12. Steps 430 to 457 then may be repeated for each additional lun of the first device 12.

In step 462, the processing means 18 determines whether there are any additional devices 12 from which performance data 14 is to be retrieved. If so, the method returns to step 430 and the query is executed with respect to the one or more sets of performance data 14 of one or more luns of the additional devices 12. Steps 430 to 460 then may be repeated for each additional device 12 in the SAN 10.

In step 465, the lun objects accumulated in the reporting list are sorted based on their assigned values in a manner determined by the input parameters 22. For example, the input parameters 22 may indicate that the lun objects be sorted according to an ascending order. In step 470, the reporting list is provided to the user 20 in a format based on the input parameters 22. For example, the user 20 may specify truncation restrictions for the reporting list.

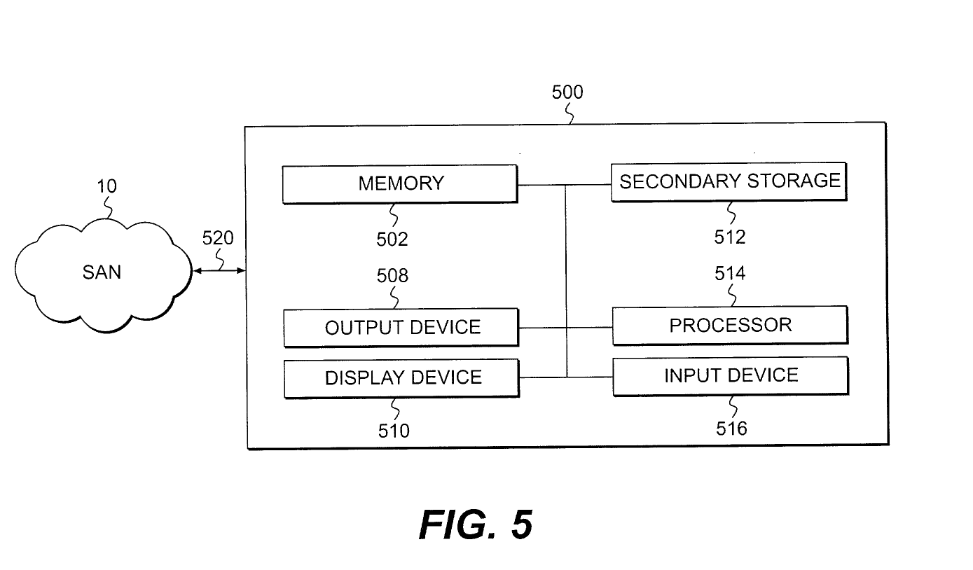

FIG. 5 illustrates exemplary hardware components of a computer 500 that may be used in connection with the method for reporting performance data for a SAN 10. The computer 500 includes a connection 520 with the SAN 10 such as the Internet or other type of computer or telephone network. The computer 500 typically includes a memory 502, a secondary storage device 512, a processor 514 (e.g., the processing means 18), an input device 516, a display device 510, and an output device 508.

The memory 502 may include random access memory (RAM) or similar types of memory. The secondary storage device 512 may include a hard disk drive, floppy disk drive, CD-ROM drive, or other types of non-volatile data storage, and may correspond with various databases or other resources. The processor 514 may execute information stored in the memory 502, the secondary storage 512, or received from the Internet or other network. Instructions for performing a method for reporting performance data for a SAN 10, such as the methods described above, may be stored in the memory 502 or the secondary storage 512. The input device 516 may include any device for entering data into the computer 500, such as a keyboard, keypad, cursor-control device, touch-screen (possibly with a stylus), or microphone. The display device 510 may include any type of device for presenting visual image, such as, for example, a computer monitor, flat-screen display, or display panel. The user 20 may, for example, enter requests for performance data and the input parameters 22 through the input device 516 and GUIs or CLUIs (not shown) displayed on the display device 510. The output device 508 may include any type of device for presenting data in hard copy format, such as a printer, and other types of output devices including speakers or any device for providing data in audio form. The computer 500 can possibly include multiple input devices, output devices, and display devices.

Although the computer 500 is depicted with various components, one skilled in the art will appreciate that the computer 500 can contain additional or different components. In addition, although aspects of an implementation consistent with the method for reporting performance data for a SAN 10 are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 500 to perform a particular method.

While the present method and system have been described in connection with an exemplary embodiment, it will be understood that many modifications will be readily apparent to those skilled in the art, and this application is intended to cover any variations thereof. For example, the present system and method may be applied to software architectures other than storage area networks.

What is claimed is:

1. A method for reporting performance data for a network, comprising the steps of:
(a) receiving a request for performance data for one or more devices in the network;
(b) retrieving the requested performance data for the one or more devices;
(c) summarizing the retrieved performance data for the one or more devices, whereby individual summaries are created;
(d) assigning a value to each individual summary, wherein the value assigned to each individual summary represents the retrieved performance data summarized over a user-specified period;
(e) sorting the individual summaries based on the assigned values, wherein the sorting step creates a list of sorted summaries; and
(f) reporting the list of sorted summaries.

2. The method of claim 1, wherein the request for performance data comprises one or more input parameters, and wherein the scope of the retrieving step is determined by the one or more input parameters.

3. The method of claim 2, wherein the retrieving step comprises retrieving performance data for a user-specified device type and for a user-specified period.

4. The method of claim 2, wherein the retrieving step comprises retrieving the individual performance data for one or more sub-units of the one or more devices.

5. The method of claim 1, wherein the retrieving step comprises generating a query to retrieve the requested performance data from a database comprising the performance data of the one or more devices.

6. The method of claim 1, wherein the sorting step comprises sorting the individual summaries in one of the following orders: an ascending order and a descending order.

7. The method of claim 1, wherein the reporting step comprises truncating the list of sorted summaries.

8. The method of claim 1, wherein the performance data comprises one or more of Device Total Operations, Port Total Received Bytes, and Lun Total Operations.

9. The method of claim 1, wherein the one or more input parameters comprise one or more of desired performance metrics, specific devices, device types, periods of time, sorting arrangements and truncation limits.

10. A system for reporting performance data for a network, comprising:
one or more devices in the network, wherein the one or more devices correspond to one or more device types; and
processing means operably coupled to the one or more devices, wherein the processing means comprises:
receiving means for receiving a request for performance data for the one or more devices, wherein the request comprises one or more input parameters;
retrieving means for retrieving the requested performance data for the devices based on the input parameters;
summarizing means for summarizing the retrieved performance data for each device, wherein individual summaries are created and a value is assigned to each individual summary, wherein the value assigned to each individual summary represents the retrieved performance data summarized over a user-specified period;
sorting means for sorting the individual summaries by the assigned values based on the input parameters, whereby a list of sorted summaries is created; and
reporting means for reporting the list of sorted summaries based on the input parameters.

11. The system of claim 10, wherein the reporting means comprises means for truncating the list of sorted summaries.

12. The system of claim 10, wherein the retrieving means comprises means for retrieving performance data for a user-specified device type and for a user-specified period.

13. The system of claim 10, wherein the retrieving means comprises means for retrieving individual performance data for one or more sub-units of the one or more devices.

14. The system of claim 10, wherein the performance data comprises one or more of Device Total Operations, Port Total Received Bytes, and Lun Total Operations.

15. The system of claim 10, wherein the retrieving means comprises a query to retrieve the requested performance data.

16. The system of claim 10, wherein the sorting means comprises means for sorting the individual summaries in one of the following orders: an ascending order and a descending order.

17. The system of claim 10, wherein the one or more input parameters comprise one or more of desired performance metrics, specific devices, device types, periods of time, sorting arrangements and truncation limits.

18. The system of claim 10, further comprising a means for generating queries based on the request for performance data, wherein the queries are capable of retrieving the requested performance data from a database comprising the performance data of the one or more devices.

19. A computer readable medium for comprising instructions for reporting performance data for a network, by:
(a) receiving a request for performance data for one or more devices in the network;
(b) retrieving the requested performance data for the one or more devices;
(c) summarizing the retrieved performance data for the one or more devices, whereby individual summaries are created;
(d) assigning a value to each individual summary, wherein the value assigned to each individual summary represents the retrieved performance data summarized over a user-specified period;
(e) sorting the individual summaries based on the assigned values, wherein the sorting step creates a list of sorted summaries; and
(f) reporting the list of sorted summaries.

20. The computer readable medium of claim 19 further comprising instructions for retrieving the requested performance data by generating a query to retrieve the requested performance data from a database comprising the performance data of the one or more devices.
